(19) United States
(12) Patent Application Publication
(10) Pub. No.: US 2016/0089700 A1
(43) Pub. Date: Mar. 31, 2016

(54) DEVICE FOR CLEANING AND DRYING ROLL STANDS

(71) Applicant: SMS Group GmbH, Duesseldorf (DE)

(72) Inventors: Wolfgang Denker, Freudenberg (DE); Bernd Zilkenat, Hilchenbach (DE)

(21) Appl. No.: 14/964,627

(22) Filed: Dec. 10, 2015

Related U.S. Application Data
(63) Continuation-in-part of application No. 13/699,771, filed on Feb. 4, 2013.

(30) Foreign Application Priority Data
Jun. 4, 2010 (DE) 102010022666.1
Aug. 7, 2010 (DE) 102010033753.6

(51) Int. Cl. B08B 3/02

(52) U.S. Cl. CPC B08B 3/02

(57) ABSTRACT

A system for use in a rolling train includes a roll stand (11) for rolling a metal stock movable along a rolling train line, rails (12) extending inside the roll stand transversely to the rolling train line, and a device for cleaning and drying at least end surfaces of spaced opposite chokes of the roll stand and movable on the rails inside the roll stand. The device has a plurality of jet nozzles, which can be directed towards the roll stand (11), for a liquid cleaning medium (16) and blow nozzles (22, 22a, 22b, 22c) for a drying medium.

### RELATED APPLICATIONS

This application is a continuation-in-part of application Ser. No. 13/699,771 filed Feb. 4, 2013 which is a National Stage Application of International Application PCT/EP2011/057629 filed May 11, 2011 and claiming priority of German applications DE 10 2010 022 666.1 filed Jun. 4, 2010 and DE 10 2010 033 753.6 filed Aug. 7, 2010, all of the above-referenced applications are incorporated herein by reference thereto.

### BACKGROUND OF THE INVENTION

1. Field of the Invention

The present invention relates to equipment for cleaning and drying roll stands, particularly roll stands in a rolling train, wherein a back-up roll change device, which is movable into the roll stand on rails transversely to the rolling line, is provided for changing the rolls.

2. Description of the Prior Art

In rolling mills, particularly double cold reduction DCR trains and reversing stands with a dressing function, the rolling mode is frequently converted from wet rolling to dry rolling or also to various emulsions or pure rolling oils. For this purpose the roll stand has to be clean and dry so as to be able to ensure the quality of the product to be rolled.

The stands of a rolling mill are usually expensively manually cleaned by means of high pressure cleaners so as to then subsequently allow them to dry. A cleaning of that kind is very intensive in terms of time and personnel. In order to avoid these disadvantages as far as possible, automated cleaning devices have been proposed.

The known automated cleaning devices provide pipe ducts, which are fixedly installed in the roll stand, with fixedly installed cleaning nozzles for the cleaning medium, for example hot water, as well as fixedly installed pipe ducts for the drying air for subsequent drying of the roll stand.

In this regard the numerous disturbing edges and obstacles which are generated by the installation itself are disadvantageous. It is proved that dead spaces and flow shadows are thereby formed. A cleaning-medium or drying-air flow which is as undisturbed as possible is virtually impossible. The contaminants actually already detached from the roll stand settle again in the dead spaces and flow shadows. In order to avoid secondary cleaning of the rolls for the intended working step it is consequently necessary for manual re-cleaning to be carried out. Since the cleaning time is directly lost as production time, this in turn has a negative effect on the cost efficiency of the entire plant.

A device for cleaning outer end faces of roll chocks is disclosed in Japanese Publication JPH09295013. This device likewise leaves dead spaces, e.g., inner end faces of the roll chocks which also require cleaning.

It is therefore an object of the present invention to create a system by which stand cleaning is possible in the shortest time with a high-quality cleaning result and without uncleaned dead spaces, so that it is possible to dispense with manual re-cleaning.

### SUMMARY OF THE INVENTION

The system according to the invention provides that the cleaning equipment, similarly to the roll change devices, is movable on the rails which extend inside the roll stand and comprises a plurality of jet nozzles, which can be oriented towards the roll stand and the inner surfaces of the chocks, for a liquid cleaning medium and blow nozzles for a drying medium.

When the cleaning equipment or device is moved inside/within the roll and, the dead spaces including the inner end faces of chocks are cleaned by varying the position of nozzles in a lateral direction.

Through these measures a device is created by which a rapid automatic cleaning of a roll stand is possible. The cleaning result and the drying result are better by comparison with conventional devices, since due to the eliminated fixed piping there are no dirt edges or drip edges in the roll stand. Moreover, a substantially better stand accessibility is present due to the eliminated fixed piping. Rolling mills integrated into strip plants can also be cleaned in the case of continuous operation with strip in the plant.

In a preferred form of embodiment of the device according to the invention the jet nozzles are constructed as rotating nozzles.

According to a particularly advantageous form of embodiment of the equipment according to the invention the jet nozzles are arranged on or in a rotatable or pivotable nozzle head.

In an advantageous form of embodiment of the equipment according to the invention the jet nozzles are designed for spraying hot water. The hot water can be provided with or without a cleaning agent additive. This is oriented towards the rolling mode (with use of emulsion or rolling oils) in which the roll stand, which is to be cleaned, has been operated.

In a further advantageous form of embodiment of the equipment according to the invention the blow nozzles are constructed as slot nozzles. The drying medium can, depending on requirements, be warm or hot compressed air. The slot nozzles can in that case be combined into one or more rotating or pivotable blow groups. In that case it is provided that the air jet dries the roll stand and drives the water in front of it until it runs off into the stand trough and collects there. The blow groups are hollow bodies constructed to be substantially cylindrical.

In a further, particularly preferred form of embodiment of the equipment according to the invention the blow nozzles are constructed as rotating slot nozzles. The moisture can thus be driven by the rotating slot nozzles uniformly ahead from the stand until running off, for example into the stand trough.

In a further advantageous form of embodiment of the equipment according to the invention the jet nozzles and the blow nozzles can be oriented in their effective direction from above to below or from below to above referred to the rolling line. It is thereby possible to very precisely position the jet nozzles and the blow nozzles in order to achieve a very good cleaning result and drying result in the region above and below the rolling stock. In that case it is advantageous to arrange the nozzles to be movable and displaceable in order to act on all potential dirt positions. In the case of blasting with cleaning agent or blowing with compressed air, preferably produced by a blower, it is thus possible to reliably reach even regions which are difficult to access. The drying is concluded in the shortest time.

According to a particularly preferred form of embodiment of the equipment according to the invention the coupling of the duct system for the jet nozzles and blast nozzles to the respective supply sources takes place automatically on movement of the backing roll change device into the roll stand.

In an advantageous form of embodiment of the equipment according to the invention the jet nozzles and the blow nozzles are adjustable and position-controlled with respect to their action, output quantity for the cleaning and drying medium, the rotational speed and their mutual spacing. It is thereby possible, for example, to automatically move slowly or even several times to difficult cleaning and blasting points.

In a further, particularly preferred form of embodiment of the equipment according to the invention the jet nozzles and the blow nozzles are part of a module movable inside the roll stand so that the cleaning and drying can take place in succession by corresponding displacement of the module transversely to the rolling line. Individual functions of cleaning and drying can also be fulfilled by two devices.

According to a further, particularly preferred form of embodiment of the equipment according to the invention it is provided that the module is mounted temporarily on the back-up roll change device.

In a further advantageous form of embodiment of the equipment according to the invention the module is temporarily introduced inside the roll stand with use of the roll change device.

According to a further, particularly preferred form of embodiment of the equipment according to the invention it is provided to construct the equipment in accordance with function as separate devices for cleaning and drying.

Additional devices, such as blowers with feed channels and heat exchangers, as well as a hot water tank, can be associated with the equipment.

### BRIEF DESCRIPTION OF THE DRAWINGS

The invention is explained in more detail in the following on the basis of an exemplifying form of embodiment with reference to the accompanying drawings, in which:

FIG. 1 shows a schematic front view of the equipment according to the invention, transversely to the rolling line, with a plurality of jet nozzles and blow nozzles able to be oriented onto the roll stand, during a cleaning process, and

FIG. 2 shows a schematic front view of the equipment according to the invention, transversely to the rolling line, during a drying process.

### DETAILED DESCRIPTION OF THE PREFERRED EMBODIMENT

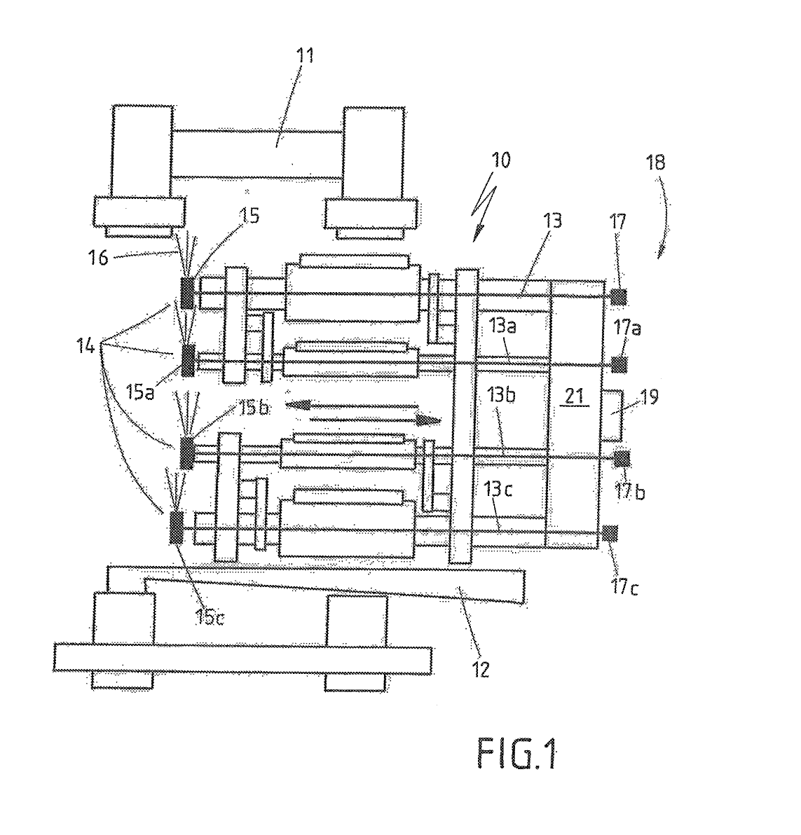

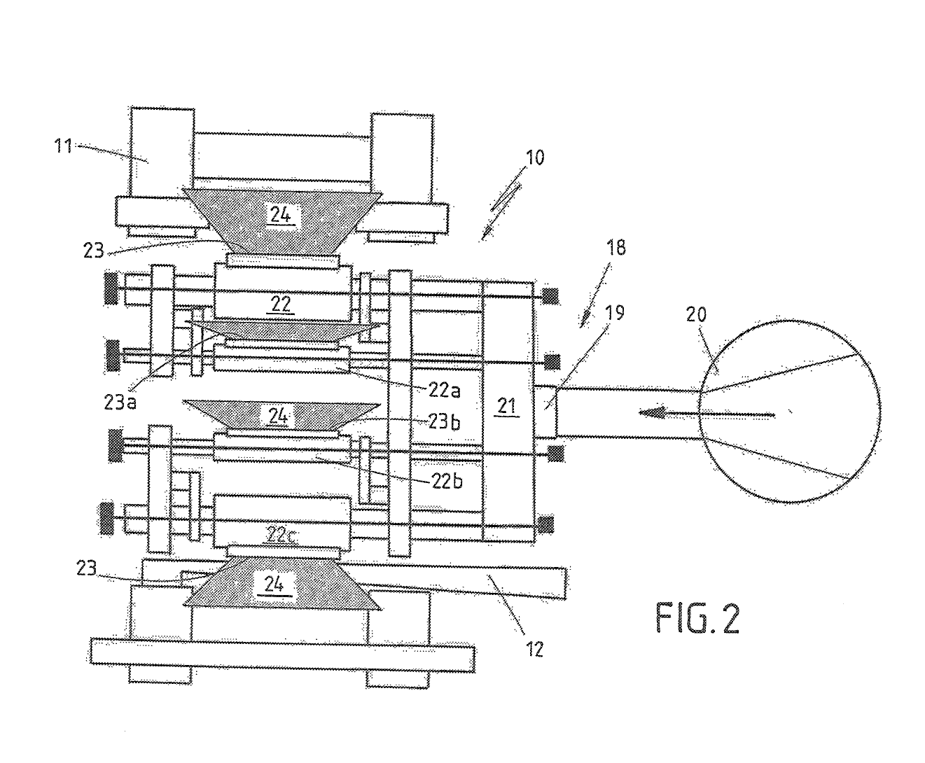

FIG. 1 and FIG. 2 show a form of embodiment of the equipment 10 according to the invention within a roll stand 11, which is part of a rolling train (not illustrated). It is provided to construct the equipment 10, similarly to the case of a back-up roll change device (not illustrated), to be movable on the rails 12. The rails 12 on which the equipment 10 can be moved inside the roll stand 11 are arranged transversely to the rolling train line.

Pressure lines 13, 13a, 13b and 13c are associated with the equipment 10. The pressure lines 13, 13a, 13b and 13c have jet nozzles 15, 15a, 15b and 15c at the respective free ends 14 thereof. A cleaning medium 16, for example water mixed with surfactants, is conducted at high pressure through the pressure lines 13, 13a, 13b and 13c.The cleaning medium 16 issues from the jet nozzles 15, 15a, 15b and 15c. The jet nozzles 15. 15a, 15b and 15c are preferably constructed to be self-rotating and are driven by the reaction force of the cleaning medium 16 when exiting from the jet nozzles 15, 15a, 15b and 15c.

The equipment 10 can be moved transversely to the rolling line, as is indicated by the arrows (← →), in the roll stand 11. In order to precisely control and monitor the position of the equipment in the roll stand 11, this is connected with a positioning control (not illustrated). The positioning control is regulated so that the jet nozzles 15, 15a, 15b and 15c are operable more intensively and/or held in position over a longer period of time. As a result, locations, which are difficult to access or strongly contaminated, of the roll stand 11 can be acted on more intensively by the cleaning medium 16, so that a very good cleaning result is achieved.

The pressure lines 13, 13a, 13b and 13c are connected by way of connecting means 17, 17a, 17b and 17c with a supply source (not illustrated) at a mobile or stationary supply module, on the connecting side 18 of the equipment 10. The connection is carried out completely automatically whilst the equipment 11 is moved into the roll stand 11 on, for example, the rails 12 of a back-up roll change device.

In another form of embodiment provision is made to replace the connecting means 17, 17a, 17b and 17c by a single connecting means in which the pressure lines 13, 13a, 13b and 13c are combined and supplied together by way of a common connecting means with the cleaning medium 16. This connecting means is similarly connected on the connecting side 18 with a supply source, namely a mobile or stationary supply module (not illustrated).

Associated with the equipment 11 on the connecting side 18 is at least one further connecting means 19, by way of which the equipment 11 can be connected with a further supply source 20, namely a mobile or stationary supply module. The equipment 11 comprises a further pressure output system 21.

Substantially cylindrically constructed blow nozzles 22, 22a and 22b, 22c are associated with the pressure duct system 21. The blow nozzles 22, 22a and 22b, 22c are constructed to be rotatable about the longitudinal axes thereof. In this form of embodiment the blow nozzles 22, 22a and 2b, 22c are constructed as rotating and pivotable slot nozzles. Through the possibility of rotation, all regions of the roll stand 11 can be uniformly blow-dried by means of a drying medium 24 supplied by way of the supply module and the coupling 19 to the pressure duct system 21. The drying medium 24 can be cold, heated or highly temperature-controlled compressed air, preferably produced by blowers.

As is illustrated particularly in FIG. 2, the slot nozzles 22, 22a and 22b, 22c have outlet openings 23, 23a, 23b and 23c, out of which the drying medium 24 flows and uniformly covers the roll stand 11. In that case the cleaning medium 16 distributed by the spray heads 15, 15a, 15b and 15c is driven by the drying medium, on movement of the equipment 11 into the roll stand 10 transversely to the rolling line (not illustrated), in front thereof. The cleaning medium 16 blown away from and dripping off the roll stand 11 is preferably collected in and discharged from a collecting trough (not illustrated) associated with the roll stand 11.

What is claimed is:

1. A system for use in a rolling train, comprises a roll stand (11) for rolling a metal stock movable along a rolling train line; rails (12) extending inside the roll stand transversely to the rolling train line; and a device for cleaning and drying at least end surfaces of spaced opposite chokes of the roll stand and movable on the rails inside the roll stand, the device having a plurality of jet nozzles, which can be directed towards the roll stand (11), for a liquid cleaning medium (16) and blow nozzles (22, 22a, 22b, 22c) for a drying medium.

2. System according to claim 1, wherein the jet nozzles are constructed as rotating and pivotable nozzles.

3. System according to claim 1, wherein the jet nozzles (15, 15a, 15b, 15c) are arranged on or in a movable nozzle head.

4. System according to claim 1, wherein the blow nozzles (22, 22a, 22b, 22c) are constructed as slot nozzles.

5. System according to claim 4, wherein the blow nozzles (22, 22a, 22b, 22c) are constructed as rotating slot nozzles.

6. System according to claim 1, wherein the jet nozzles (15, 15a, 15b, 15c) and the blow nozzles (22, 22a, 22b, 22c) are oriented in an operational direction thereof so that the jet and blow nozzles act in direction from above the rolling line to below the rolling line or from below the rolling line to above the rolling line.

7. System according to claim 1, wherein coupling of a duct system (21; 13, 13a, 13b, 13c) for the jet nozzles (15, 15a, 15c) and the blow nozzles (22, 22a, 22b, 22c) to a respective supply sources (20) is carried out one of automatically and manually when the rolling change device moves into the roll stand (11).

8. System according to claim 1, wherein the jet nozzles (15, 15a, 15b, 15c) and the blow nozzles (22, 22a, 22b, 22c) are set and positionally controlled with respect to their action, output quantity for the cleaning medium (16) and drying medium (24), movement speed, and mutual spacing.

9. System according to claim 1, wherein the jet nozzles (15, 15a, 15b, 15c) and the blow nozzles (22, 22a, 22b, 22c) are part of a module movable into the roll stand (11) so that the cleaning and drying can take place in succession by corresponding displacement of the module transversely to the rolling line.

10. System according to claim 9, wherein the module is temporarily introduced into the roll stand, using the roll change device.

11. System according to claim 9, wherein the system is constructed in accordance with its function as separate units for cleaning and drying.
